(19) United States
(12) Patent Application Publication
(10) Pub. No.: US 2025/0376598 A1
(43) Pub. Date: Dec. 11, 2025

(54) System and Method for Production and use of a Photonic Crystal Printing Ink Solution

(71) Applicant: Cypris Materials, Inc., Berkeley, CA (US)

(72) Inventors: Matthew David Ryan, Berkeley, CA (US); Ryan Michael Pearson, Berkeley, CA (US); Tri R. Tuladhar, Cambridge (GB); Alexander Hess, Oakland, CA (US); Luke Whitson, Oakland, CA (US)

(73) Assignee: Cypris Materials, Inc., Berkeley, CA (US)

(21) Appl. No.: 19/000,439

(22) Filed: Dec. 23, 2024

Related U.S. Application Data
(63) Continuation of application No. 17/673,433, filed on Feb. 16, 2022, now abandoned.
(60) Provisional application No. 63/149,943, filed on Feb. 16, 2021.

(51) Int. Cl. C09D 11/037; B41M 5/00; B41M 7/00; C09D 11/107; C09D 11/32; C09D 11/40

(52) U.S. Cl. CPC C09D 11/037; B41M 5/0023; B41M 7/0081; C09D 11/107; C09D 11/32; C09D 11/40

(57) ABSTRACT

Systems and methods used for or in connection to production and printing of a photonic crystal forming ink solution, which involve use of a block polymer mixture and optionally a solvent, wherein the color of the printed ink solution may be set either through a single or multiple block polymer mixtures (i.e. premixed coloring) or through printing multiple layers of distinct single or multiple block polymer mixtures (i.e. post print coloring). The composition(s) used by the systems and methods function as a structural color (i.e., a photonic crystal) precursor, wherein forming, loading, printing, and optional post-print processing of the ink solution on a substrate, function to provide a desired photonic crystal print object possessing reflective coloration properties.

### CROSS-REFERENCE TO RELATED APPLICATIONS

This Application is a continuation of U.S. patent application Ser. No. 17/673,433, filed Feb. 16, 2022, which claims the benefit of U.S. Provisional Application No. 63/149,943, filed Feb. 16, 2021, the disclosures of which are incorporated herein by reference in their entirety.

### STATEMENT REGARDING FEDERALLY SPONSORED RESEARCH

This invention was made with government support under 1940383 awarded by the National Science Foundation. The government has certain rights in the invention.

### TECHNICAL FIELD

This invention relates generally to the field of photonic crystal formation, and more specifically to a new and useful system and method for creating and printing a photonic crystal forming ink solution.

### BACKGROUND

Color formation, particularly the creation of new colors for use, has been a field of development for thousands of years. Although research and development has been continuing, the technology of color formation and then applying/printing has been mostly focused on developing new colors through the development of dyes and pigments.

Dyes are typically organic compounds that are either extracted from plants or synthetically produced (e.g., indigo or alizarin). Dyes provide a useful coloring, that may or may not be toxic, and are limited in variety. Additionally, printing/applying dyes to substrates (e.g., garments) may require strong organic solvents that may be toxic. Pigments are dry coloring matter, usually insoluble particles mixed with solvents, typically derived from coal tars and petrochemicals. Pigments provide a much broader variation of colors, as compared to dyes, but can be much more toxic.

Dyes and pigments thus suffer from many limitations. For example, dyes and pigments are limited by having to find and create new chemistries to create new colors. For example, to access a red and blue dye or pigment separately, two different molecules must be synthesized. Many dyes and pigments are potentially toxic, which may include danger in creating and/or using them. Material colored with dyes or pigments tend to fade over time as the dye or pigment slowly disperses and/or degrades (e.g., the chromophore that gives rise to color may degrade) over time. Additionally, effect pigments (also referred to as interference pigments) comprise particles that are comparatively large, limiting their utilization in printing, particularly inkjet printing.

Structural color, specifically the subset of synthetic photonic crystals, offer an alternative to dyes and pigments to impart value-added optical effects to objects. The reflective coloration imparted by photonic crystals is due to the physical geometry of the material, not an absorption band like a traditional dye. As such, synthetic photonic crystals offer the potential to decouple the color produced by the material from the chemical functional groups, avoiding the need for toxic and unstable chromophores.

Thus, there is a need in the fields of color formation, reflective material formation, and printing for a more consistent way of color formation and printing that is non-toxic, is not limited by creating or finding new chromophores, has unique optical properties, and does not fade over time. This invention provides such a new and useful systems and methods.

### BRIEF DESCRIPTION OF THE FIGURES

FIG. 1 is an illustration of typically implemented color gamuts.

FIG. 2 is a plot of a benchmark inkjet ink solution.

FIG. 3 is a plot of a non-optimal inkjet ink solution.

FIG. 4 are images of suboptimal droplet formation.

FIG. 5 are formulations of example system ink solutions.

FIG. 6 are plots of the viscoelastic properties of example system ink solutions.

FIG. 7 are formulations of example system ink solutions containing a co-binder.

FIG. 8 is a plot of the viscoelastic properties of an example system ink solution.

FIG. 9 are images of successful droplet formations with an example system ink solution.

FIG. 10 are images of successful droplet formations with an example system ink solution.

FIG. 11 is an image of a photonic crystal printout.

FIG. 12 are formulations of example system ink solutions forming structurally colored printed objects.

FIG. 13 is a formulation of an example radical curing screen-printing solution forming a structurally colored object.

FIG. 14 is a formulation of an example cationic curing screen-printing solution forming a structurally colored object.

FIG. 15-16 are the optical measurements of structurally colored objects for some include example systems.

FIG. 17 is a schematic of a printing system.

FIG. 18 is a flowchart of a method for printing with a photonic crystal forming ink solution.

### DESCRIPTION OF THE EMBODIMENTS

The following description of the embodiments of the invention is not intended to limit the invention to these embodiments but rather to enable a person skilled in the art to make and use this invention.

### 1. Overview

Systems and methods for or in connection to production and printing of a photonic crystal forming ink solution can involve use of a block polymer mixture and a solvent, wherein the color of the printed ink solution may be set either through a single or multiple block polymer mixture (i.e., premixed coloring) or through printing multiple layers of distinct single or multiple block polymer mixtures (i.e., post print coloring). The composition(s) used by the systems and methods function as a structural color (i.e., a photonic crystal) precursor, wherein formulating, loading, printing, and optional post-print processing of the ink solution on a substrate, function to provide a desired photonic crystal print object possessing reflective properties.

The systems and methods may be applied in any field or application that requires reflective inks or coatings. Fields that require high end coloration, such as cosmetics, printing, sporting goods, packaging, security markings, and automotives may find the systems and methods particularly useful. The systems and methods may be implemented for any coloring and/or printing application. The systems and methods are particularly suited for inkjet printing in general, and more specifically to industrial inkjet printing. The systems and methods may additionally be implemented for other types of printing, including, but not limited to: screen printing, thermal printing, flexographic printing, and roto-gravure printing.

The systems and methods may provide a number of potential benefits. Colors created through photonic crystal forming inks may be significantly less toxic as compared to currently used pigments and dyes.

Additionally, objects coated with photonic crystal forming inks may be more compatible with current recycling processes.

Additionally, objects with photonic crystal forming inks may possess unique optical properties.

Additionally, the system and method may provide the benefit of a simplified formulation workflow to generate a multitude of different colors from a low number of material inputs.

Additionally, photonic crystal forming inks may provide a more “resilient” form of printing that is less susceptible to fading as compared to conventional pigments and dyes.

For inkjet printing, the systems and methods may enable printing of polymeric molecules of higher molecular weight, or “larger”, than those currently used. That is, brush block copolymers may provide lower solution viscosity and shear thinning properties that enable ink jet printing of “larger” polymers.

The systems and methods may provide a cheaper method of printing reflective materials as compared to current technologies. Through the use of a co-binder, the systems and methods may provide a significantly larger volume of printable ink solution at a lower cost, as compared to current products.

The systems and methods may provide a method of printing ultraviolet reflective coatings spanning, but not limited to, 200-400 nm wavelengths.

The systems and methods may provide a method of printing visible light reflective coatings spanning, but not limited to, 400-750 nm wavelengths.

The systems and methods may provide a method of printing infrared reflective coatings spanning, but not limited to, 750-2000 nm wavelengths.

The systems and methods may provide a method of printing new or augmented color gamuts as compared to current technologies. Through the use of additive color mixing, the systems and methods may provide colors that cannot be achieved through currently available pigments, dyes, and generally through applications of subtractive mixing theories.

Additionally, the systems and methods may provide an enhancement when used with pigments and dyes. The systems and methods may enable a wider range of colors, including unique colors, through combining photonic crystal forming ink with pigments and dyes to create a color gamut through a mixture of subtractive and additive color mixing theories.

The systems and methods may provide a number of potential benefits. The systems and methods are not limited to always providing such benefits and are presented only as exemplary representations for how the systems and methods may be put to use. The list of benefits is not intended to be exhaustive and other benefits may additionally or alternatively exist.

### 2. Composition for an Ink Solution (System 1)

A composition for a printable photonic crystal forming, ink solution, includes: at least one block copolymer 110, and at least one solvent 120. The composition functions as a non-particulate printing matter solution, that forms a reflective structure (i.e., structural color) once deposited onto a substrate. That is, the composition functions as a block copolymer-based solution, optimized and/or enhanced for printing; wherein the composition, once “printed”, is deposited as a “film” onto a print surface with the appropriately designated surface area, thickness, color, and design, as determined by the print method and desired implementation.

In preferred variations, the photonic crystal structure has a relatively periodic microstructure within the deposited film with an average periodicity appropriate to a desired color wavelength (or desired color wave band). The system may vary greatly dependent on implementation (e.g., due to the implemented type of printing method, implemented printer, the target substrate, and the desired output). Dependent on the implementation, the solution may additionally include: cosolvents, co-binders and swelling agents, as well as paint, ink, or coating additives such as, but not limited to, surfactants, humectants, crosslinkers, photoinitiators, photosensitizers, leveling agents, adhesion promoters, rheological modifiers, plasticizers, stabilizers, and any number of other additives.

As used herein, substrate refers to any surface that the composition may be applied to. Dependent on implementation and ink solution composition, the applicable substrate may vary. Examples of potential substrates may include: packaging materials, sporting goods, automotive surfaces, credit cards, watch faces, footwear, paper, organic cloth, synthetic cloth, plastics, metals, walls, etc.

As a “coloring” property of the ink solution, the ink solution composition enables combinations of different color ink solutions to create different mixture colors. The ink solution may enable both additive coloring (e.g., RGB coloring of monitors) and subtractive coloring (e.g., CYMK coloring of printers). As part of additive coloring, ink solutions for different colors may be mixed, creating new color films that correspond to an averaging of wave lengths of the photonic crystal forming ink solutions. This mixing may occur prior to printing the composition onto a substrate or may occur as part of a printing process wherein the ink solutions mix during or after deposition on the substrate. As part of subtractive coloring, different ink solutions may be layered, in conjunction with pigments or dyes, such that each ink solution film layer absorbs a desired color spectra leaving behind the desired color.

Additionally, color mixing may be performed by depositing different ink solutions on the substrate, curing or drying between the separate depositions. Through this method, considering a standard base of colors (e.g., RGB coloring), colors besides the base colors can be obtained through sequential deposition of either blue, green, or red constituent layers.

In some variations, the ink composition may be used for pointillistic “coloring”. That is, small dots of varying colors can be deposited such that individual dots are not distinguishable by the human eye without magnification.

The measurement of color values may be done using the L*a*b* color space. The L*a*b* color space or the L*a*b* color model (i.e., the CIELAB color model) is known to a person skilled in the art. The L*a*b* color model is standardized e.g., in DIN EN ISO/CIE 11664-4:2020-03. Each perceivable color in the L*a*b *-color space is described by a specific color location within the coordinates {L*,a*,b*} in a three-dimensional coordinate system. The a *-axis describes the green or red portion of a color, with negative values representing green and positive values representing red. The b *-axis describes the blue and yellow portion of a color, with negative values for blue and positive values for yellow. Lower numbers thus indicate a more bluish color. The L *-axis is perpendicular to this plane and represents the lightness. The L*C*h color model is similar to the L*a*b* color model, but uses cylindrical coordinates instead of rectangular coordinates. In the L*C*h color model, L* also indicates lightness, C* represents chroma, and h is the hue angle. The value of chroma C* is the distance from the lightness axis (L*). The values are measured by making use of a Konica Minolta CM5 spectrophotometer. Analysis of the samples is done in accordance with the Konica Minolta CM5 standard operating procedure.

As used herein, a reference to a color, print color, or design, refers to an ink solution, that when applied to a substrate and dried, forms a photonic crystal (a structural color), wherein the nano- or micro-structured material (e.g., through a self-assembly process) reflects the preferred print color and/or design. For example, a reference to a green ink solution refers to an ink solution that, when dried, leaves behind a photonic crystal that reflects green light. Additionally, dependent on implementation, the “purity” or chroma of the green color may also be manipulated. That is, dependent on implementation, a green ink solution may refer to an ink solution, that when dried, leaves behind photonic crystals that only reflects green light (i.e., a narrow wave band of light reflection around the range of wavelengths that are observed as green) or may refer to an ink solution that primarily reflects green light (i.e., a broad band of light is reflected with a peak reflection around green). Depending on implementation, the structural color ink solution may dry to leave a photonic crystal structure that has any desired reflection spectra.

The system enables construction of a reflective photonic crystal structure that may either reflect a very narrow band of wavelengths or a broad band of wavelengths. Thus, analogous to print color, as used herein, wavelength (or reflecting wavelength), will generally refer to a band of wavelengths of the electromagnetic spectrum. Unless stated otherwise, the use of the term wavelength (or the term color) does not in any way limit this invention to a wavelength in the visible spectrum and/or to a narrow or broad band of wavelengths.

In one variation, a composition for a printable photonic crystal forming ink solution could include: at least one block polymer and at least one solvent.

In another variation, the composition for a printable photonic crystal forming ink solution could include: at least one block polymer; at least one solvent; and at least one swelling polymer.

In another variation, the composition for a printable photonic crystal forming ink solution could include: at least one block polymer; at least one solvent; and at least one co-binder.

In another variation, the composition for a printable photonic crystal forming ink solution could include: at least one block polymer; at least one solvent; at least one swelling polymer; and at least one co-binder.

In another variation, the composition for a printable photonic crystal forming ink solution could include: at least one block polymer; at least one solvent; and at least one co-binder; wherein the at least one solvent includes a reactive monomer or oligomer.

In another variation, the composition for a printable photonic crystal forming ink solution could include: at least one block polymer; at least one solvent; and at least one co-binder; wherein the at least one solvent includes water.

In another variation, the composition for a printable photonic crystal forming ink solution could include: at least one block polymer; at least one solvent; and at least one co-binder, wherein the at least one co-binder includes crosslinking functional groups.

In another variation, the composition for a printable photonic crystal forming ink solution could include: at least one block polymer; at least one solvent; and at least one co-binder, wherein the co-binder comprises sucrose acetate iso-butyrate (SAIB-100).

In another variation, the composition for a printable photonic crystal forming ink solution could include: at least one block polymer; at least one solvent; and at least one co-binder, wherein the co-binder comprises a cellulose ester resin.

In another variation, the composition for a printable photonic crystal forming ink solution could include: at least one block polymer; at least one solvent; and at least one co-binder, wherein the co-binder comprises sucrose benzoate.

In another variation, the composition for a printable photonic crystal forming ink solution could include: at least one block polymer; at least one solvent; a swelling agent; and at least one co-binder, wherein the at least one co-binder includes a crosslinking molecule.

In another variation, the composition for a printable photonic crystal forming ink solution could include: at least one block polymer; at least one solvent; at least one co-binder, wherein the at least one co-binder includes a crosslinking molecule; and a swelling agent, wherein the swelling agent contains crosslinking functional groups.

In another variation, the composition for a printable photonic crystal forming ink solution could include: at least one block polymer; at least one solvent; and at least one co-binder, wherein the at least one co-binder includes a crosslinking molecule. This variation may further include a combined dry state prior to the addition of the at least one solvent, such that with addition of the at least one solvent, becomes a functional printable photonic crystal forming ink solution.

In another variation, the composition for a printable photonic crystal forming ink solution could include: at least one block polymer; at least one solvent; and at least one co-binder; wherein the viscosity of the ink is tuned for applicability to inkjet printing; 1-20 cP at 25 degrees Celsius.

In another variation, the viscosity of the ink is tuned for applicability in screen printing; 1,000 cP to 10,000 cP at 25 degrees Celsius.

In another variation, the composition for a printable photonic crystal forming ink solution could include: at least one block polymer; at least one solvent; and at least one

co-binder; wherein the viscosity of the ink is tuned for applicability to flexographic and gravure printing; 10 cP to 300 cP at 25 degrees Celsius.

As in these, and all variations, modification of the temperature will change the viscosity.

The system may include at least one block copolymer 110. The block copolymer 110 functions as the scaffold to form the ordered nano- or micro-structure from which colors arise. That is, block copolymers 110 may enable the ink solution to self-organize into the photonic crystals, i.e., structural colors. Each block copolymer 110 comprises molecules in arrangements (e.g., linear, brush, star) of blocks linked together through their reactive ends. Each block copolymers 110 is capable of forming different ordered phases at nano- to micro-scopic length scales. Each block copolymer may correspond to a specific color and/or at least one block copolymer may correspond to an ink solution with multiple block copolymers, such that together they correspond to one color.

The brush block copolymer, and the corresponding constituents the brush block copolymer may be prepared in the general manner as described in WO 2020/180427 and US 2021/0395463 A1. Additionally or alternatively, other methods may be incorporated for preparing the brush block copolymer.

Dependent on implementation, the at least one block copolymers 110 may comprise up to 80%, by weight, of the ink solution. In one implementation, block copolymers 110 comprise about 1-10% of the ink solution. In another implementation, block copolymers 110 comprise 10%-20% of the ink solution. In another implementation, block copolymers 110 comprise 20%-30% of the ink solution. In another implementation, block copolymers 110 comprise 30%-40% of the ink solution. In another implementation, block copolymers comprise 40%-50% of the ink solution. In another implementation, block copolymers 110 comprise 50%-60% of the ink solution. In another implementation, block copolymers 110 comprise 60%-70% of the ink solution. In another implementation, block copolymers comprise 70%-80% of the ink solution. In another implementation, block copolymers 110 comprise 80%-90% of the ink solution.

The at least one block copolymers 110 may include any type of block copolymers as needed or required by implementation. Examples of block copolymer 110 types include: brush block copolymers, wedge-type block copolymers, hybrid wedge copolymers, linear block copolymers, or any other type of block copolymers. Dependent on implementation, all block polymers may be of a single type or different types. For example, in one implementation the at least one block copolymer 110 may comprise two brush block copolymers. In another example, the at least one block copolymer 110 may comprise two brush block copolymers and a wedge-type block copolymer. In a third example, the at least one brush block copolymer 110 comprises a single block copolymer that includes both brush blocks and linear blocks.

In some variations, the at least one block copolymer 110 includes a brush block copolymer (also known as block polymers with a bottle brush polymer architecture, or graft copolymers). In some implementations, the brush block copolymer may have a tuned grafting density (e.g., by copolymerization of polymeric macromonomers and reactive diluents). Additionally or alternatively, the at least one block copolymer may include multiple brush block copolymers. Brush block copolymers may provide shear thinning properties, i.e., lack of polymer chain entanglements of brush block copolymers may lead to a solution with reduced viscosity, as compared to a “typical” solution with polymers of similar size and/or similar molecular weight but with no brush architecture. Brush block copolymers with varied grafting densities may be prepared in the general manner as described within US 2021/0395463 A1, and the supporting information of T.-P. Lin et al., JACS 2017, 139 (10), p. 3896-3903, and the supporting information of T.-P. Lin et al., ACS Nano, 2017, 11 (11), p. 11632-11641.

In some brush block copolymer variations, block copolymers 110 may utilize highly tunable brush block copolymers. These brush block copolymers may have more than one polymer block, wherein at least one of which has one or more preselected properties. For example, for a graft copolymer with two polymer blocks (a first polymer block and a second polymer block) implementation, the first polymer block may have a preselected graft density, preselected graft distribution, and/or preselected degree of polymerization. The second polymer block may, or may not, have a preselected graft density, graft distribution, and/or degree of polymerization. The second polymer block (and potentially any additional polymer blocks of the graft copolymer for a more general implementation) may be the same or distinct as desired by implementation. In this manner the block copolymer may have highly tunable and deterministic nature; which may in turn contribute to the high tunability and versatility of the self-assembled structures, and associated methods, of the present invention.

In any embodiment of the brush block copolymers, the brush block copolymer may have a preselected graft density. The preselected graft density may be any value selected from the range of 0.01 to 1.00 (unitless ratio density). In other words, the diluent and macromonomer, and the amount (concentrations) of these building blocks may be preselected so as to result in a preselected graft density that is any value in the range of 0.01 to 1.00. That is, in any embodiment of the methods of synthesizing a graft copolymer disclosed herein, the graft density may be selected from the range of 0.01 to 1.00. For example, dependent on implementation, the said graft density may be selected from the range of 0.01 to 0.32, 0.32 to 0.34, 0.34 to 0.49, 0.49 to 0.51, 0. 51 to 0.65, 0.65 to 0.68, 0.68 to 0.75, or 0.75 to 1.00.

In variations where the at least one block copolymer comprises multiple brush block copolymers, a first brush block copolymer may have a preselected first graft density (also referred to above as the graft density). Additional, brush block copolymers, i.e., a second brush block copolymer, a third brush block copolymer, . . . , a Nth brush block copolymer, may thus have corresponding preselected graft densities, i.e., a second graft density, a third graft density, . . . , a Nth graft density. As described previously, variations in the grafting density may also occur within each block copolymer, wherein distinct blocks of distinct block copolymers may have distinct properties (e.g., distinct graft densities). In any embodiment of the methods of the brush block copolymers disclosed herein, any said graft density (i.e., the first graft density through the Nth graft density), may be selected from the range of 0.01 to 1.00. In any embodiment of the methods of synthesizing a graft copolymer disclosed herein, any said graft density (i.e., the first graft density through the Nth graft density), may be selected from the range of 0.01 to 1.00. In any embodiment of the methods of synthesizing a graft copolymer disclosed herein, any said graft density (i.e., the first graft density through the Nth graft density), may be selected from the range of 0.01 to 0.32, 0.32 to 0.34, 0.34 to 0.49, 0.49 to 0.51, 0. 51 to 0.65, 0.65 to 0.68, 0.68 to 0.75, or 0.75 to 1.00.

The polymer molecular weights: number average molecular weight (Mₙ) and weight average molecular weight (Mw); and a molecular weight distribution: PDI: polydispersity index) may be determined via gel permeation chromatography (GPC) using a combination of differential refractive index (dRI) and two light scattering (LS) detectors. The use of LS detectors enables analysis of the absolute molecular weight for polymer samples. The solvent used for all samples was tetrahydrofuran (THF), with the elution rate of 1.0 mL/minute. Polymer samples were fully dissolved in HPLC grade THF at concentrations ranging from 2.5-7.5 mg/mL, passed through 0.5 μm syringe filters, and injected via autosampler. The porous column stationary phase consisted of two Malvern T600 single pore columns with exclusion limits of 20,000,000 Da for poly(styrene). Molecular weights and PDIs were determined via OMNISEC software.

Generally, a sample of brush block copolymer contains a distribution of molecular weights, as quantified by the PDI. Modification of the PDI may function to increase or decrease the intensity, and/or lambda max of the reflected wavelength(s) (the wavelength of the strongest reflection) of the deposited coating containing brush block copolymer. In many variations, the uniformity of brush block copolymers may be controlled by the production conditions. In one variation of the brush block copolymers, a polydispersity index of the graft copolymer may be selected from the range of 1.00 to 1.30. In another variation, the polydispersity index of the graft copolymer may be selected from the range of 1.00 to 1.20. In another variation, the polydispersity index of the graft copolymer may be selected from the range of 1.00 to 1.10.

In some variations, each block copolymer from the at least one the block copolymer 110, may include a molecular structure(s) that organizes into photonic crystals. Depending on implementation, the block copolymer 110 may provide the scaffolding for a structure such that once dried, will form the desired color composition (i.e., form photonic crystals that reflect the desired wavelength(s) of light). In one variation, the block copolymer 110 comprises a single block molecular structure, wherein the single block solution forms a photonic crystal with specific reflected wavelength. Alternatively, the block copolymer 110 may have multiple blocks, wherein the multiple block solution forms a photonic crystal with specific reflected wavelengths corresponding to each block. In certain variations, the composition exhibits a photonic band gap (wavelength of maximum reflection) at a wavelength in a range from about 200 nm to about 2000 nm.

In other variations, the composition may exhibit a photonic band gap at a wavelength in a range from about 200 nm to 400 nm, from 400 nm to 750 nm, from 750 nm to 1600 nm, or any combination of two or more of these ranges. In other variations, the at least one block copolymer 110 comprises two or more block copolymers. For example, the at least one block copolymer 110 comprises a mixture of two block copolymers, a first block copolymer and a second block copolymer, wherein the block copolymer mixture solution forms a specific color photonic crystal through the mixture solution. Through the use of two or more block copolymers 110, a spectrum of colors may be created by varying the relative concentration of the first block copolymer to the concentration of the second block copolymer. That is, an ink solution comprising of just the first block copolymer 110 may provide a first color; and an ink solution comprising of just the second block copolymer may provide a second color. Ink solutions comprising varying ratios of the first block copolymer 110 and the second block copolymer, may have any color from the spectrum of colors between the first color and the second color dependent on the ratio of the number of first block copolymers to the number of second block copolymers.

In some variations, the at least one block copolymer 110 may comprise three, or more, block copolymers. In the same manner as two block copolymers, the relative ratio of each block copolymer may determine the color and other properties of the ink solution. A mixture of a plurality of block copolymers 110 may be used to generate any range of colors, with varying reflectivity, chromaticity, opacity, and brightness.

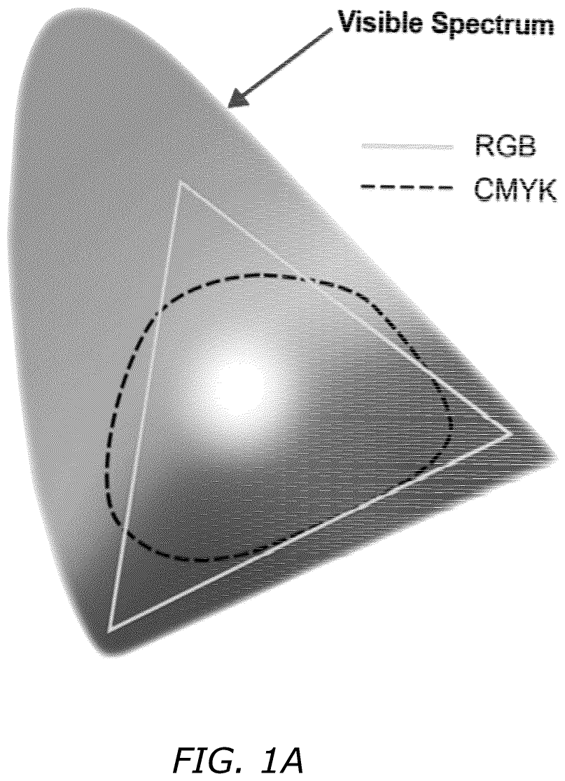

In one variation, the system may comprise multiple photonic crystal forming ink solutions, wherein each ink solution includes at least one block copolymer 110. In this variation, each ink solution (based on its corresponding block copolymer mixture) may correspond to a specific color. Different colors may then be generated by mixing or overlaying (e.g., by printing different concentrations of different ink solutions on top of each other) by through additive coloring. For example, the system may comprise a first ink solution corresponding to a first color (e.g., red), a second ink solution corresponding to a second color (e.g., green), and a third ink solution corresponding to a third color (e.g., blue). By layering different concentrations of the three ink solutions, colors in the RGB gamut may be obtained, as shown in FIG. 1. In an analogous manner, any general additive coloring gamut may be obtained.

The ink solution may include a solvent 120. The solvent functions to help maintain the solubility of other ink solution components. In many variations, the system may additionally include multiple solvents 120, i.e., cosolvents, wherein the solvents/cosolvents may provide additionally desired properties to the ink solution. Dependent on the implementation, a wide variety of solvents may be used to provide the desired properties necessary for the implementation. For example: the solvent 120 may enable the modification of the coating properties of the solution, provide a scope of slower or faster drying compatible with printers, optimize printing/jetting with inkjets, help modify ink solution viscosity, and/or modify ink solution drying rates on printed media. Dependent on the implementation, the solvent 120 may itself be a reactive component. That is, in some variations, the solvent 120 may comprise a reactive component such as: an acrylate or methacrylate monomer or oligomer, or epoxy monomer or oligomer, or any combination therein. In one variation, the solvent 120 includes a reactive monomer or oligomer. Alternatively, the solvent may comprise other reactive components. A reactive component solvent 120 may be necessary for the use of UV curable ink compositions. Solvents 120 may include water or any suitable conventional organic solvents to those skilled in the art and can be used as organic solvents or co-solvents in the ink solution formulations. The term “organic solvent” is known to those skilled in the art, in particular from Council Directive 1999/13/EC of 11 Mar. 1999. Examples of such organic solvents would include heterocyclic, aliphatic, or aromatic hydrocarbons, or their partially fluorinated variants, such as, for example, 4-chlorobenzotrifluoride, mono- or polyhydric alcohols, especially methanol and/or ethanol, 1-methoxy-2-propanol, 1-propoxy-2-propanol, benzyl alcohol, butyl lactate, ethers, esters, such as, for example, ethyl acetate, propyl acetate, butyl acetate, pentyl acetate, ketones, such as, for example, acetone, cyclohexanone, methyl ethyl ketone, methyl isobutyl ketone, isophorone, and amides, such as, for example, N-methylpyrrolidone, N-ethylpyrrolidone, dimethylformamide, toluene, xylene, butanol, ethyl glycol and butyl glycol and also their acetates, ethyl glycol and butyl glycol and also their ether acetates, butyl diglycol, diethylene glycol dimethyl ether, or mixtures thereof.

In some variations, the system may include at least one swelling agent. The at least one swelling agent may comprise up to 70% of the ink composition. The at least one swelling agent may function to modulate the solution viscosity (e.g., modulate the viscosity by 2-4 orders of magnitude) and/or alter the color of the coatings. In some variations, the swelling agent may comprise a linear polymer. Examples of linear polymer swelling agents may include: optionally substituted aliphatic polyesters, poly(amino acids), copoly(ether-esters), polyalkylenes oxalates, poly-amides, poly(iminocarbonates), polyorthoesters, polyoxaesters, polyamidoesters, polyoxaesters containing amine groups, poly(anhydrides), polyphosphazenes, polysiloxanes, polyethylene, polyethylene terephthalate, poly(tetrafluoro-ethylene), polycarbonate, polypropylene, poly lactic acid (PLA), polyglycolic acid (PGA), polycaprolactone (PCL), poly(Lactide-co-Glycolide) (PLGA), polydioxanone (PDO), trimethylene carbonate (TMC), polyethyleneglycol (PEG), polyurethanes, polyacrylonitriles, polyanilines, polyvinyl carbazoles, polyvinyl chlorides, polyvinyl fluorides, polyvi-nyl imidazoles, polyvinyl alcohols, polystyrenes and poly (vinyl phenols), aliphatic polyesters, polyacrylates, polymethacrylates, polystyrenes, chlorosulphonated poly-olefins, and copolymers thereof. Additionally or alternatively, block or nonlinear polymer architectures of the above may be used as swelling agents (e.g. star, dendritic, cyclic).

In some variations, the swelling agent may include the above polymers with modifications enabling self-crosslinking or crosslinking with other molecules or compounds.

In some variations, the system may include at least one co-binder component (also referred to as a filler). The co-binder may provide a multitude of functions. The function of the co-binder may include lowering the solution viscosity, raising the solution viscosity, improving the mechanical properties of the ink solution as a coating, improving the coating durability, lowering the glass transition temperature of the coating, raising the glass transition temperature of the coating, improving coating performance in the presence of temperature cycling, providing water resistance of the coating, providing humidity resistance of the coating, improving the ink solution wetting on substrates, improving the coating adherence on the substrate, improving the optical properties of the coating through improved chroma, improving the optical properties of the coating through reduced haze. Generally speaking, the co-binder may include any non-volatile material that is not a brush block copolymer or swell polymer. The co-binder may be reactive or unreactive. In variations where a reactive co-binder is implemented, the co-binder may provide crosslinking, adhesion, or other “binding” properties. Dependent on implementation, the co-binder may comprise a minority or majority proportion of the composition. The co-binder may include polymer resins comprised of polystyrenics, polyesters, polyolefins, polyvinyl ethers, polyethers, polyacrylates, polymethacrylates, polyacrylamides, polymethacrylamides, polyurethanes, polysiloxanes, polyamides, polyethylene terephthalates, polybutylene terephthalates, polyvinyl chlorides, melamine resins, phenolic resins, urea resins, alkyd resins, epoxy resins, polyetherketones, polyphenylene sulfides, polyvinyl alcohols, and/or their copolymers, and/or their acrylate/methacrylate functionalized variants, and/or their epoxy functionalized variants. The co-binder may include cellulose ester resins or sucrose ester compounds. The co-binder 140 may comprise up to 70% of the solution. In some variations, the co-binder may include cellulose acetate butyrate resins. In some variations, the co-binder comprises sucrose acetate iso-butyrate (SAIB-100). In some variations, the co-binder comprises sucrose benzoate.

In some variations, the ink solution may include one or more stabilizers. Stabilizers function to improve the stability of the ink solution, i.e., improve the solution lifespan and/or solution solubility. Stabilizers may also function to improve the stability of the coating. Examples of stabilizer types include: UV absorbers (e.g. benzotriazoles), hindered amine light stabilizers (HALS), antioxidants, and thiosynergists. In some variations, crosslinking functional groups may be incorporated. Depending on variation, crosslinking functional groups may be incorporated with the co-binder and/or swelling agent. In some variations, suitable crosslinking functional groups may contain one or more olefinic double bonds. They can be of high molecular weight (oligomeric) or low molecular weight (monomeric). Examples of monomers with a double bond are alkyl or hydroxyalkyl acrylates or methacrylates, for example methyl acrylate, ethyl acrylate, butyl acrylate, 2-ethylhexyl acrylate or 2-hydroxyethyl acrylate, isobornyl acrylate, tetrahydrofurfuryl acrylate, methyl methacrylate, or ethyl methacrylate. Examples of monomers having two or more double bonds are ethylene glycol diacrylate, propylene glycol diacrylate, neopentyl glycol diacrylate, hexamethylene glycol diacrylate, or bisphenol A diacrylate, trimethylolpropane triacrylate, pentaerythiritol triacrylate or tetraacrylate, divinylbenzene, divinyl succinate, diallyl phthalate, triallyl phosphate, triallyl isocyanurate or tris(2-acryloylethyl) isocyanurate. Examples of higher molecular weight (oligomeric) polyunsaturated compounds are acrylicized epoxy resins, polyurethanes, polyethers and polyesters which are acrylized or contain vinyl ether or epoxy groups. Further examples of unsaturated oligomers are unsaturated polyester resins which are mostly prepared from maleic acid, phthalic acid and one or more diols and have molecular weights of from about 500 Da to 3,000 Da. In some variations, suitable crosslinking functional groups may contain one or more epoxy units. Said component is preferably a cycloaliphatic epoxy compound, and/or it may be a glycidyl ether compound. The cycloaliphatic epoxy compound can be a cycloalkane oxide-containing compound obtained by epoxidizing a cycloalkane-containing compound with an oxidizing agent. The cycloalkane of the cycloalkane oxide-containing compound can be a cyclohexene or cyclopentene. The glycidyl ether compound can be a di- or polyglycidy; ether obtained by reacting an aliphatic polyhydridic alcohol or an alkylene oxide adduct thereof, and epichlorohydrin. Examples of the polyhydridic alcohols include alkylene glycols, such as ethylene glycol, propylene glycol, and 1,6-hexanediol. In some variations, suitable crosslinking functional groups may contain an oxetane or polyol. In some variations, suitable crosslinking functional group may contain one or more vinyl ether compounds. Examples include di- or tri-vinyl ether compounds, such as ethylene glycol divinyl ether. Diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether.

The ink solution may contain one or more photoinitiators. Phosphine oxides are well known photoinitiators for the photopolymerization of ethylenically unsaturated compounds. Examples of commercially available products of the phosphine oxide compounds include IRGACURE 819 (BASF SE) and DAROCUR TPO (BASF SE). Alpha-hydroxy ketone compounds are also potential photoinitiators. Examples of commercially available products of the alpha-hydroxy ketone compounds include ESACURE KIP 150 (from DKSH Management, ltd), IRGACURE 127 (BASF SE), IRGACURE 2959 (BASF SE), and IRGACURE 184 (BASF SE).

The ink solution may also include a photosensitizer. Such a photosensitizer is suitably arranged to absorb radiation from a light source and facilitate transfer of energy to a photoinitiator. Photosensitizers may include an anthracene, pyrene, carbazole, thiazine, phenothiazine or thioxanthene moiety.

In some variations, the composition may further comprise a substrate, wherein the printable photonic crystal ink solution is applied to the substrate. That is, the composition may comprise a printable photonic crystal ink solution, comprising: at least one block polymer, at least one solvent, and at least one co-binder; and a substrate; wherein the printable photonic crystal ink solution forms a structural color film on the substrate. Dependent on implementation, as described above, the printable photonic crystal ink solution may include additional cosolvents, swelling agents, as well as paint, ink, and coating additives. The substrate may comprise any appropriate surface, or porous material, that through application of the printable photonic crystal ink solution, enables formation of the colored film surface on, or through (for porous materials), the substrate. Dependent on implementation, the substrate may comprise organic or inorganic materials. Examples of substrates include: skin, organic tissue, organic fabric, synthetic fabric, wood, metal, cement, plastic, stone, plaster, walls, and membranes.

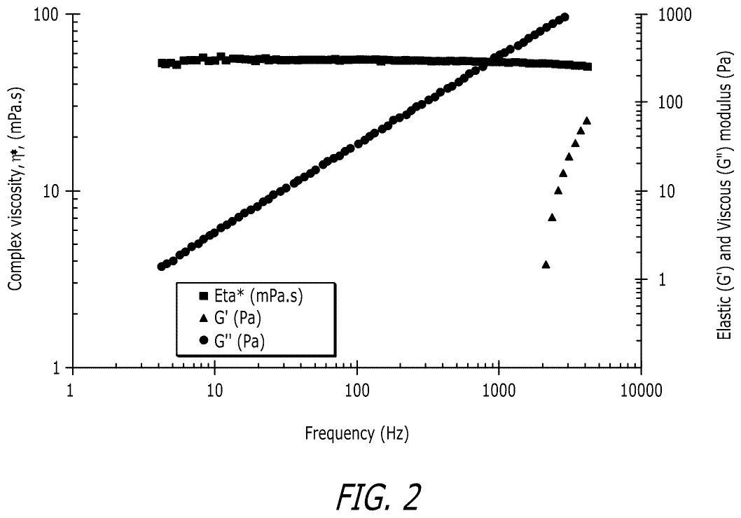

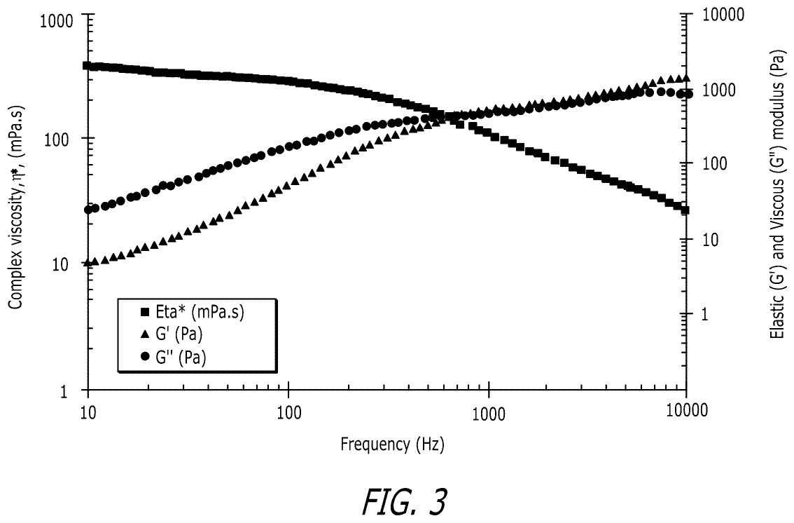

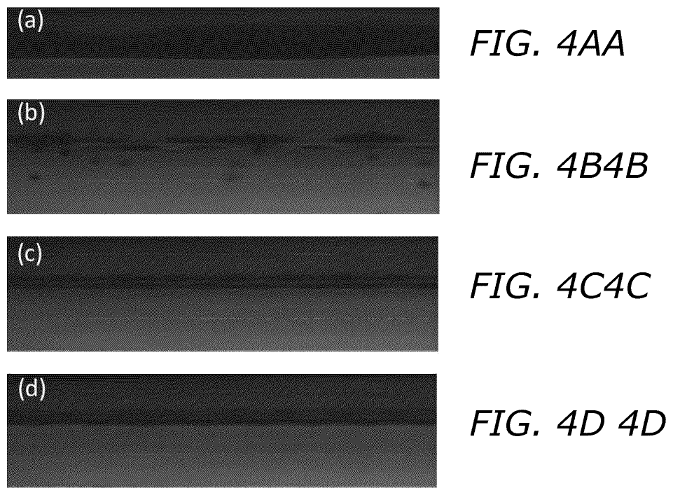

As described above, the system may have many variations of ink compositions. Herein, multiple example ink composition systems for inkjet printing are presented. In addition to the ink solution components mentioned above, for successful inkjet printing preferably, certain rheological conditions must also be achieved. As shown in the benchmark ink solution example of FIG. 2, the viscosity preferably uniform or decreases as the frequency of oscillation increases (black curve) and the elastic and viscous modulus increase with frequency, wherein the elastic modulus is continuously below the viscous modulus (red curves). In comparison, an alternative unsuccessful rheology for inkjet printing, as shown in FIG. 3, the elastic modulus dominates over the viscous modulus at higher, printing frequencies. Additionally, appropriate conditions of the inkjet (e.g., temperature and inkjet frequency) are also required for a successful ink solution. As shown in FIG. 4, several failed inkjet droplet formation attempts are shown.

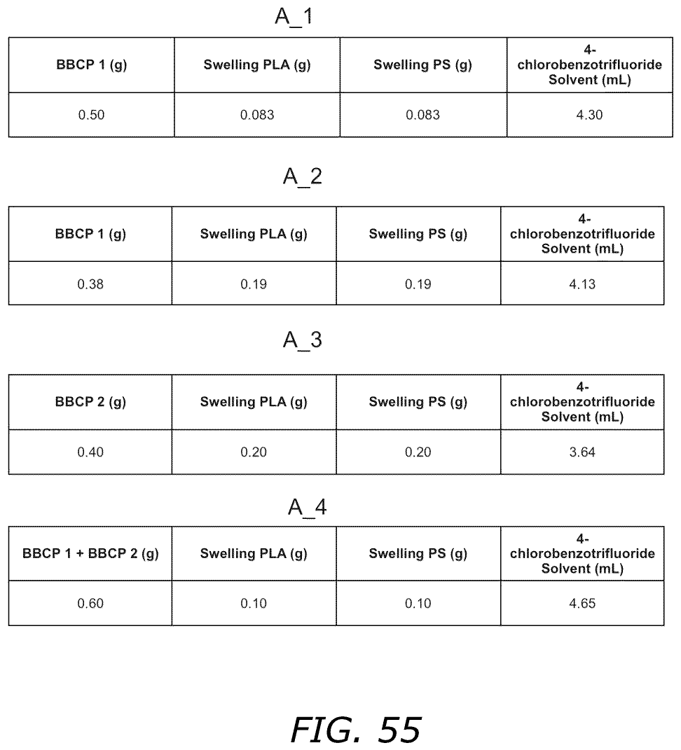

In a first variation for an inkjet ink solution, as shown in FIG. 5, the solution comprises at least one block copolymer, at least one swelling agent and a solvent. The at least one swelling agent comprises polylactic acid (PLA) and polystyrene (PS) and the solvent comprises 4-chlorobenzotrifluoride. The at least one block copolymer may be any block copolymer and/or combination of block copolymers (e.g., a combination of block copolymers that print to a desired color).

In one example (A1), the at least one block copolymer concentration is approximately 5%-10%, the PLA concentration is approximately 1.0%-7.5%, the PS concentration is approximately 1.0%-7.5%, and 4-chlorobenzotrifluoride comprises approximately 82%-92% of the solution.

In a second example (A2) the at least one block copolymer concentration is approximately 5%-10%, the PLA concentration is approximately 2.5%-7.5%, the PS concentration is approximately 2.5%-7.5%, and 4-chlorobenzotrifluoride comprises approximately 79.5% %-89.5% of the solution.

In a third example (A3), the at least one block copolymer concentration is approximately 5%-10%, the PLA concentration is approximately 2.5%-7.5%, the PS concentration is approximately 2.5%-7.5%, and 4-chlorobenzotrifluoride comprises approximately 79%-89% of the solution.

In a fourth example (A4), the at least one block copolymer concentration is approximately 5%-10%, the PLA concentration is approximately 1.0%-7.5%, the PS concentration is approximately 1.0%-7.5%, and 4-chlorobenzotrifluoride comprises approximately 80%-90% of the solution.

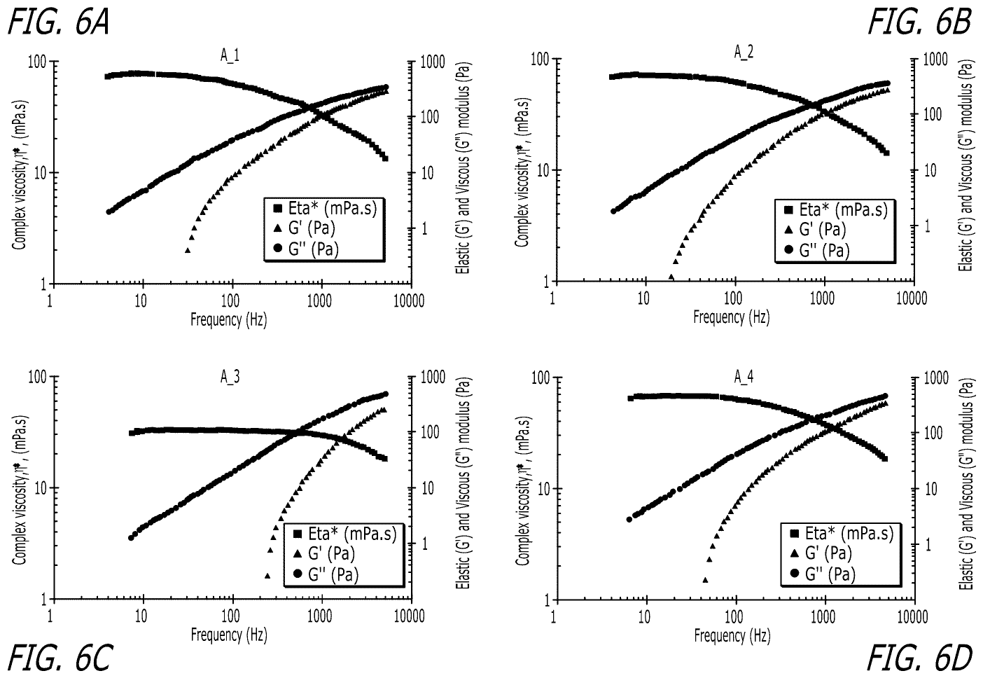

As shown in FIG. 6, these four examples (i.e., A1, A2, A3, and A4) of the first variation meet the criteria of a uniform or decreasing viscosity, and increasing elastic and viscous moduli, as a function of frequency. Additionally, the viscous modulus is continuously greater than the elastic modulus.

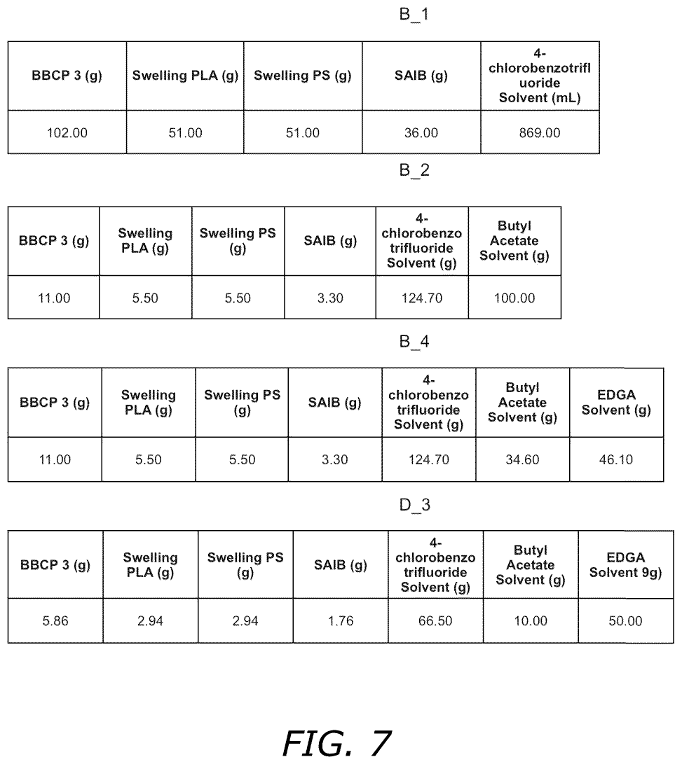

In a second variation for an inkjet ink solution, as shown in FIG. 7, the solution comprises at least one block copolymer, at least one swelling agent, at least one co-binder, and a solvent. The at least one swelling agent comprises polylactic acid (PLA) and polystyrene (PS), the at least one co-binder comprises SAIB-100, and the solvent comprises 4-chlorobenzotrifluoride. The at least one block copolymer may be any block copolymer and/or combination of block copolymers (e.g., a combination of brush block copolymers that print to a desired color).

In one example of the second variation (B1), the at least one block copolymer concentration is approximately 5%-10%, the PLA concentration is approximately 2.5%-7.5%, the PS concentration is approximately 2.5%-7.5%, the SAIB-100 is approximately 1%-5%, and the 4-chlorobenzotrifluoride solvent comprises approximately 75%-85% of the solution.

In a second example of the second variation (B2), the solution further comprises a butyl acetate co-solvent. In the second example, the at least one block copolymer concentration is approximately 2.5%-7.5%, the PLA concentration is approximately 1%-5%, the PS concentration is approximately 1%-5%, the SAIB-100 is approximately 1%-5% the butyl acetate co-solvent is approximately 35%-45% of the solution, and the 4-chlorobenzotrifluoride solvent is approximately 45%-55% of the solution.

In a third example of the second variation (B4), the solution further comprises an ethylene glycol diacetate co-solvent in addition to the butyl acetate co-solvent and the 4-chlorobenzotrifluoride solvent. In the third example, the at least one block copolymer concentration is approximately 2.5%-7.5%, the PLA concentration is approximately 1%-5%, the PS concentration is approximately 1%-5%, the SAIB-100 is approximately 1%-5%, the butyl acetate co-solvent is approximately 10%-20% of the solution, the EDGA co-solvent is approximately 15%-25% of the solution, and the 4-chlorobenzotrifluoride solvent is approximately 45%-55% of the solution.

In a fourth example of the second variation (D3), the at least one block copolymer concentration is approximately 2.5%-7.5%, the PLA concentration is approximately 1%-5%, the PS concentration is approximately 1%-5%, the SAIB-100 is approximately 1%-5%, the butyl acetate co-solvent is approximately 2.1%-12.5% of the solution, the EDGA co-solvent is approximately 30.7%-40.7% of the solution, and the 4-chlorobenzotrifluoride solvent is approximately 42.5%-52.5 of the solution.

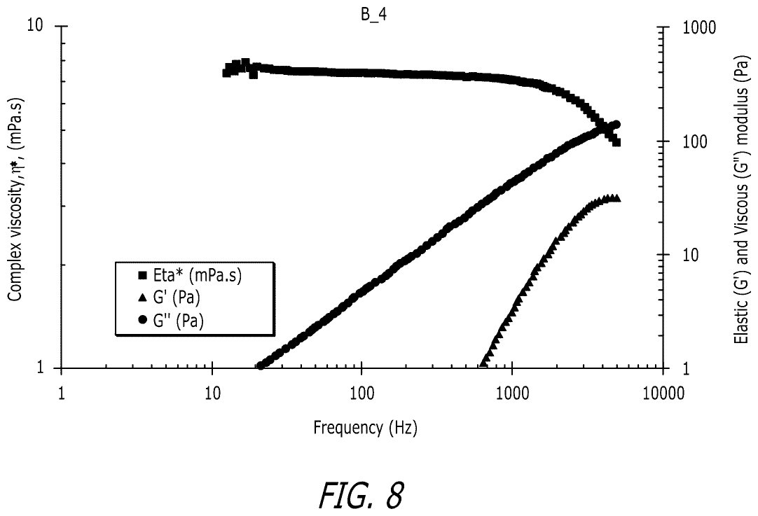

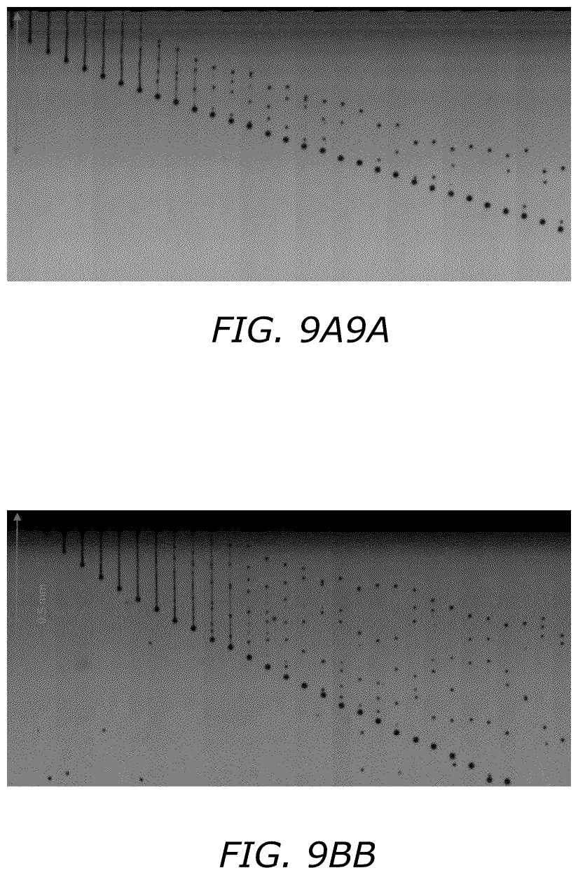

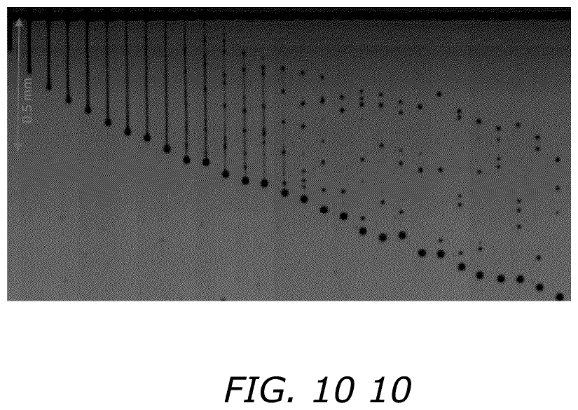

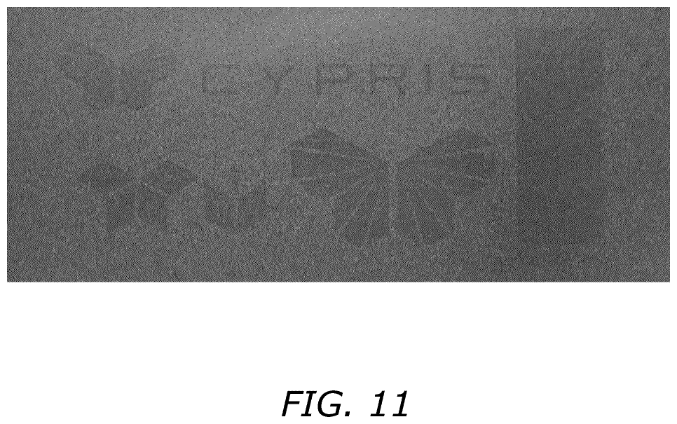

As shown in FIG. 8, for the third example of the second variation, B4 meets the criteria for successful ink jetting. As shown in FIG. 9, successful jetting with the B4 ink solution may be accomplished, wherein the jetting occurs at 25 C printing at 2 k Hz jetting frequency. As shown in FIG. 10, for the fourth example of the second variation, successful jetting with the D3 ink solution may also be accomplished, wherein the jetting occurs with a drive voltage of 22 V and a drop velocity of 4.1 m/s. FIG. 11 shows a sample print using the D3 ink solution with the appropriate print parameters.

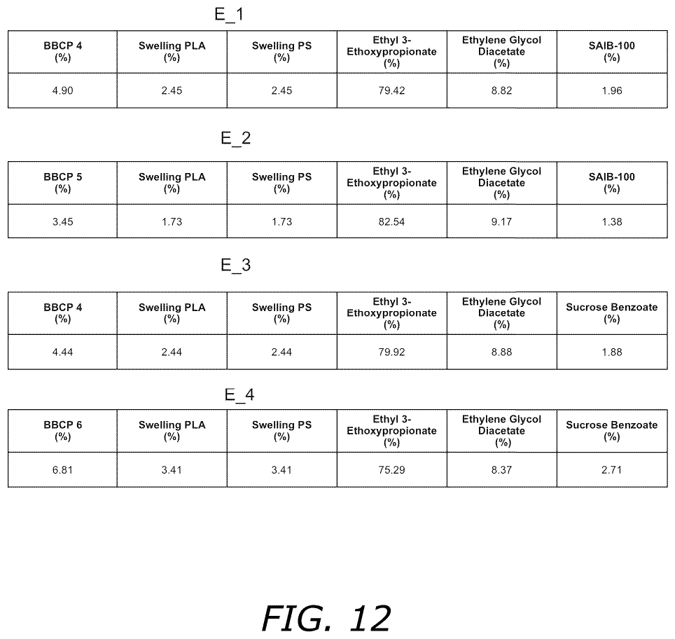

In a third variation for an inkjet solution, as shown in FIG. 12, the solution comprises at least one block copolymer, at least one swelling agent, at least one co-binder, and at least one solvent. The at least one swelling agent comprises polylactic acid (PLA) and polystyrene (PS), the at least one co-binder comprises SAIB-100 or Sucrose Benzoate, and the at least one solvent comprises ethyl 3-ethoxypropionate and ethylene glycol diacetate.

In one example of the third variation (E1), the at least one block copolymer (BBCP4) concentration is approximately 2.5%-7.5%, the PLA concentration is approximately 1%-4%, the PS concentration is approximately 1%-4%, the SAIB-100 is approximately 1%-4%, the ethyl 3-ethoxypropionate co-solvent is approximately 60%-85% of the solution, and the ethylene glycol diacetate co-solvent is approximately 5%-10% of the solution.

In a second example of the third variation (E2), the at least one block copolymer (BBCP5) concentration is approximately 2.5%-7.5%, the PLA concentration is approximately 1%-4%, the PS concentration is approximately 1%-4%, the SAIB-100 is approximately 1%-4%, the ethyl 3-ethoxypropionate co-solvent is approximately 60%-85% of the solution, and the ethylene glycol diacetate co-solvent is approximately 5%-10% of the solution.

In a third example of the third variation (E3), the at least one block copolymer (BBCP4) concentration is approximately 2.5%-7.5%, the PLA concentration is approximately 1%-4%, the PS concentration is approximately 1%-4%, the Sucrose Benzoate is approximately 1%-4%, the ethyl 3-ethoxypropionate co-solvent is approximately 60%-85% of the solution, and the ethylene glycol diacetate co-solvent is approximately 5%-10% of the solution.

In a fourth example of the third variation (E4), the at least one block copolymer (BBCP6) concentration is approximately 2.5%-7.5%, the PLA concentration is approximately 1%-4%, the PS concentration is approximately 1%-4%, the Sucrose Benzoate is approximately 1%-4%, the ethyl 3-ethoxypropionate co-solvent is approximately 60%-85% of the solution, and the ethylene glycol diacetate co-solvent is approximately 5%-10% of the solution.

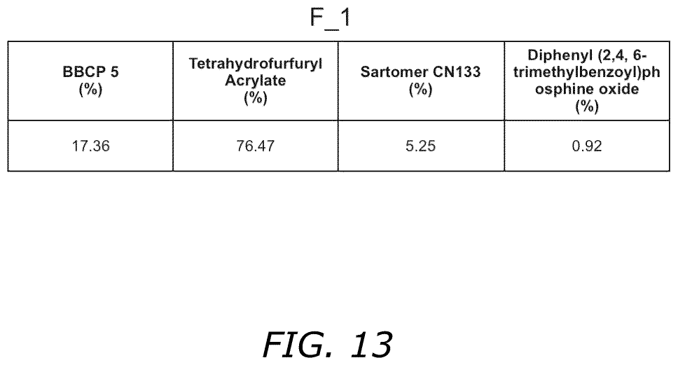

In a variation for a radical curing screen-printing solution (F1), as shown in FIG. 13, the solution comprises at least one block copolymer, at least one reactive co-binder, at least one reactive solvent, and at least one photoinitiator. The at least one block copolymer comprises BBCP5, the reactive solvent comprises tetrahydrofurfuryl acrylate, the reactive co-binder comprises aliphatic triacrylate oligomer Sartomer CN133, and the photoinitiator is Diphenyl (2,4,6-trimethylbenzoyl) phosphine oxide.

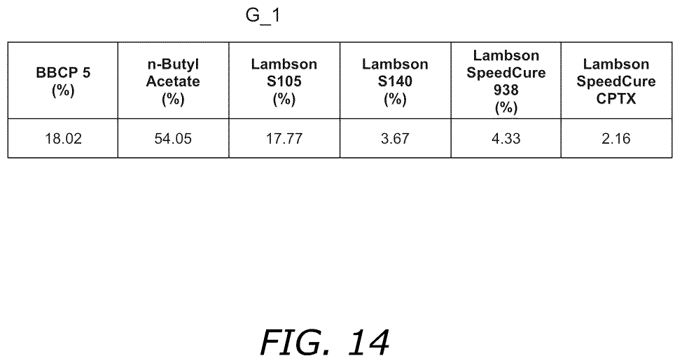

In a variation for a cationic curing screen-printing solution (G1), as shown in FIG. 14, the solutions comprise at least one block copolymer, at least one solvent, at least one reactive co-binder, at least one additive, at least one photoinitiator, and at least one photosensitizer. The at least one block copolymer is BBCP5, the solvent is butyl acetate, the at least one reactive co-binder is difunctional cycloaliphatic epoxide Lambson UviCure S105, the at least one additive is a monofunctional oxetane Lambson UviCure S140, the at least one photoinitiator is cationic photoinitiator of the iodonium hexafluorophosphate family Lambson SpeedCure 938, and the at least one photosensitizer is a thioxanthone Lambson SpeedCure CPTX.

As described previously, the at least one block copolymer included in the ink solution may be implementation specific and may be varied as desired. Herein several sample brush block copolymers are presented that may be used individually, together, or as part of a separate mixture of the at least one block copolymer. Example brush block copolymers may have a number average molecular weight (Mn) in the range of 400 kDa to 4,000 kDa, more preferably in the range of 500 kDa to 3,000 kDa, and even more preferably in the range 600 kDa to 2,500 kDa. A first example brush block copolymer (BBCP1) may have a Mn of 1,072 kDa and a weight average molecular weight (Mw) of 1,890 kDa, with a polydispersity index (PDI) of 1.126. A second example brush block copolymer (BBCP2) may have a number average molecular weight (Mn) of 799.4 kDa and a weight average molecular weight (Mw) of 850.9 kDa, with a polydispersity index (PDI) of 1.064. A third example brush block copolymer (BBCP3) may have a number average molecular weight (Mn) of 1,072 kDa and a weight average molecular weight (Mw) of 1,180 kDa, with a polydispersity index (PDI) of 1.101. A fourth example brush block copolymer (BBCP4) may have a number average molecular weight (Mn) of 541.0 kDa and a weight average molecular weight (Mw) of 585.1 kDa, with a polydispersity index (PDI) of 1.082. A fifth example brush block copolymer (BBCP5) may have a number average molecular weight (Mn) of 2,088 kDa and a weight average molecular weight (Mw) of 2,236 kDa, with a polydispersity index (PDI) of 1.071. A sixth example brush block copolymer (BBCP6) may have a number average molecular weight (Mn) of 1,287 kDa and a weight average molecular weight (Mw) of 1,396 kDa, with a polydispersity index (PDI) of 1.085. Formulations containing the BBCPs preferably form reflective coatings in the wavelength range 200 nm to 1600 nm. As desired per implementation, these sample brush block copolymers may be incorporated as part of the previously described example ink solutions. The sample brush block copolymers may be incorporated as single brush block copolymers in the ink solution, or as a mixture of two or more brush block copolymers; wherein the ratio of the brush block copolymers may set the ink solution color. Sample examples of these implementations are presented in FIGS. 5, 6, 12. 13. and 14. For example, in an implementation of A1, the at least one block copolymer comprises BBCP1. In one example of an implementation of A2, the at least one block copolymer comprises BBCP1. In one example of one implementation of A3, the at least one block copolymer comprises BBCP2. In one example of one implementation of A4, the at least one block copolymer comprises a desired ratio of BBCP1 and BBCP2.

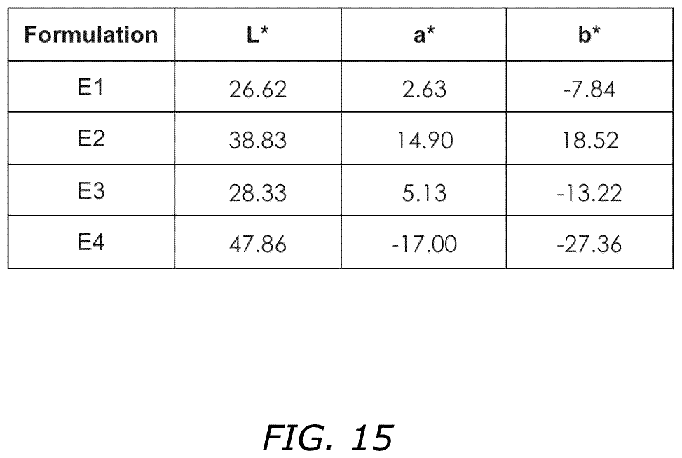

In one example of one implementation of B1, the at least one block copolymer comprises BBCP3. In one example of one implementation of B2, the at least one block copolymer comprises BBCP3. In one example of one implementation of B4, the at least one block copolymer comprises BBCP3. In one example of one implementation of D3, the at least one block copolymer comprises BBCP3. In one example of one implementation of E1, the at least one block copolymer comprises BBCP4. In one example of one implementation of E2, the at least one block copolymer comprises BBCP5. In one example of one implementation of E4, the at least one block copolymer comprises BBCP6. Optical samples for each formulation are given in FIG. 15, wherein each sample was produced using an inkjet printing and printing each sample with 60 passes at 1kHz frequency, in binary print mode.

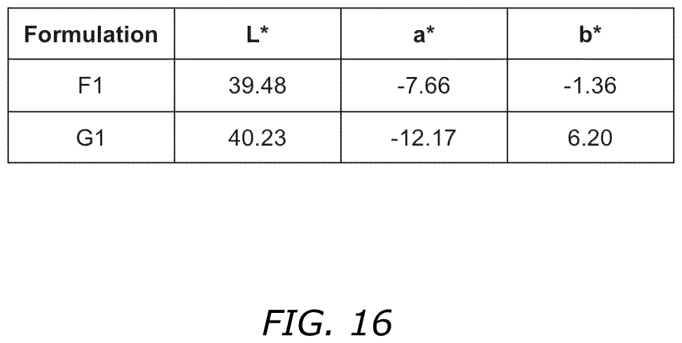

In one example of one implementation of F1, the at least one block copolymer comprises BBCP5. In one example of one implementation of G1, the at least one block copolymer also comprises BBCP5. Optical samples for each formulation are given in FIG. 16, wherein each sample was produced using screen printing.

### 3. Printing System

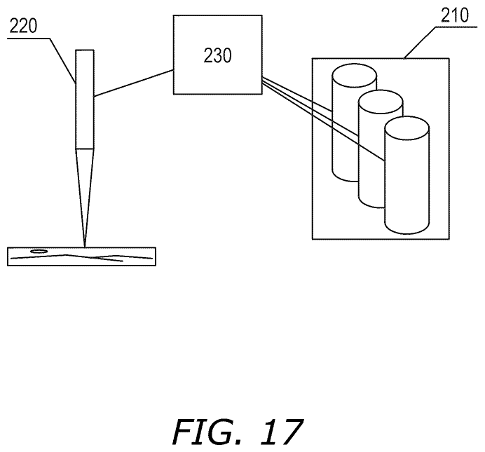

As shown in FIG. 17, a printing system for a structural ink includes: an ink reservoir system 210 comprising at least a first ink reservoir, wherein: each ink reservoir contains a structural ink solution, and the first ink reservoir contains a first structural color solution, wherein the first structural color solution comprises a first distinct block copolymer, or a first distinct blend of block copolymers; a depositing system 120, enabled to deposit a print solution onto a substrate, thereby creating a photonic crystal deposition; and a loading mechanism 130, connected to the ink reservoir system and the depositing system, that once a print order is received, constructs the print solution by loading the appropriate structural color solutions, in the appropriate quantities, into the depositing mechanism. The system functions to enable structural color printing. That is, the system stores, prepares, and prints structural color designs onto a substrate.

The printing system may be incorporated with and make use of any structural color printable ink solution, or combination of any structural color printable ink solution and another type of color solution (e.g., pigment or dye), but may be particularly applicable for use with the ink composition described herein. Additionally, the system may be part of any currently available system and/or method of print, wherein this printing system provides components for use of the structural ink for printing. Although this document will focus on this printing system with incorporation of ink jet printing, the system may be generally used with any appropriate system and method for printing. Examples of other printing techniques/systems that may be incorporated with this system include: inkjet, offset, flexographic, screen, roto-gravure, etc.

In some variations of the printing system, the included printer components are inkjet printer components. Examples of the included printer components are: an inkjet well, an inkjet printer head, a premixing fluidic system, and/or a heating element.

As used herein, substrate refers to any object, material, and/or surface appropriate to receive the print solution; wherein once the print solution is “printed” onto the substrate, the print solution dries to a film comprising a periodic photonic crystal structure. Dependent on the printing type, desired substrate, and desired implementation, system components may include variances to improve print onto the substrate. Appropriate substrates may be dependent on the specific structural color solution formulation. Examples of possible substrates include: paper, metal, wood, fabric (organic, or synthetic), stone, plastic, biological (e.g., human skin).

The system may include an ink reservoir system 110. The ink reservoir system 110 functions to store structural color solutions, and to keep the solutions easily accessible for use. The ink reservoir system 110 includes at least a first ink reservoir (also referred to as well), wherein the first ink reservoir stores the first structural color solution.

A single ink reservoir system may be good for implementations that will only do single color printing. For variations that use multi-color printing, two ink reservoirs may be used. The system may have any number of ink reservoirs, wherein each ink reservoir contains a distinct structural color solution. That is, generally, for an N-reservoir system, a first ink reservoir contains a first structural color solution, a second ink reservoir contains a second structural color solution, additional ink reservoirs may be included such that an Nth ink reservoir contains an Nth structural color solution.

For example, for a 2-reservoir system, a first reservoir may contain a first structural color solution (e.g., red), and a second reservoir may contain a second structural color solution (e.g., blue). For a 3-reservoir system example, a first reservoir may contain a first structural color solution (e.g., red), a second reservoir may contain a second structural color solution (e.g., green), and a third reservoir may contain a third structural color solution (e.g., blue). For a 4-reservoir system example, a first reservoir may contain a first structural color solution (e.g., red), a second reservoir may contain a second structural color solution (e.g., green), and a third reservoir may contain a third structural color solution (e.g., blue), and a fourth reservoir may contain a fourth non-structural color solution (e.g., a black dye or pigment).

In some inkjet implementations, the reservoir system 110 may include inkjet wells, wherein the ink reservoirs are the inkjet wells. The inkjet well may function to store the ink solution. In some variations the inkjet well may comprise a multi-well, i.e., a well with multiple storage chambers. Each well of the multi-well may store a distinct ink solution. Distinct ink solutions may be mixed for different color solutions. The multi-well may also enable mixing of the distinct ink solutions. In variations where the ink solution is used as part of a premixing printer implementation, the printer components may include a fluidic system or other suitable ink mixing mechanism such that the printer components may enable mixing of different concentrations of the distinct ink solutions to produce a spectrum of colors prior to printing (e.g., before jetting mixed ink out of an inkjet printer head). In a post printing mixing implementation (e.g., for an additive or hybrid additive/subtractive coloring implementation wherein multiple layers of distinct ink solution colors are layered on top of each other), the multi-well may enable storage and eventual dispersion (e.g., by an inkjet printer head) of the ink solution.

The reservoir system may additionally include components or properties to help maintain and stabilize the structural color solutions. Examples of components that may be included as part of the reservoir system or within each ink reservoir include: a heating element (e.g., for heated storage to improve viscosity) and a mixing element (e.g., to prevent the structural color solution from separating, settling, etc.).

The system may include a depositing system 220. The depositing system 220 functions to “print” the print solution onto the substrate. Dependent on the implementation, the depositing system 220 may set the speed, thickness, and design of the print, as the print solution is deposited onto the substrate.

Dependent on the implementation, the depositing system 220 may print an entire design (project, color, etc.) in one pass onto the substrate. Alternatively, the depositing system may “pass” over the substrate multiple times, where each pass may include different colors, a different color pass.

In some inkjet variations, the depositing system 220 may include an inkjet printer head. The inkjet printer head may function to enable dispersion of the ink solution on a substrate. The inkjet printer head may be of any desired type. Examples of inkjet printer heads include: MEMS printer heads, piezoelectric printer heads, thermal inkjet printer heads, continuous inkjet printer heads, and/or any other desired type of printer head. As part of the ink solution dispersion, the inkjet printer head may enable a specific inkjet firing frequency, droplet size of ink solution, and nozzle density. In some variations, the inkjet printer head may additionally have a tunable drive voltage (e.g., a MEMS printer head). Through the depositing system, ink properties may be modified by altering the print frequency, and the print waveform. In variations that include piezoelectric printer head, the waveform may be modified through altering the voltage.

The system may include a loading mechanism 230. The loading mechanism may be connected to the ink reservoir system 210 and the depositing system 220. The loading mechanism functions to prepare the print solution (for printing) from the structural color solutions. For a single-color implementation, the loading mechanism 230 may just directly transfer the first structural color solution to the depositing system 220. For multi-color implementations, the loading mechanism 230 may choose the time and quantity of each structural color to transfer to the depositing system 220. This may be particularly true for preprint coloring implementations. In some variations, the loading mechanism 230 may function in conjunction with the depositing system 220. That is, the loading mechanism 230 may continuously “load” the depositing system 220 during function of the printing system.

In variations where color is set prior to printing (i.e., preprint color); the loading mechanism may include a mixing apparatus. The mixing apparatus functions to combine different structural color solutions into a single print solution. That is, for a desired print color and desired volume of print (and potential other print properties, e.g., viscosity), the loading mechanism obtains the correct ratio of all the required structural color solutions and deposits them into the mixing apparatus, wherein they are sufficiently homogenized into a single print solution.

In one example, the mixing apparatus contains a mechanical mixer/stirrer. In another example, the mixing apparatus contains a magnetic mixer. Examples of methods of mixing that may be used by the mixing apparatus includes: high shear mixing, sonication, centrifugation, and planetary mixing.

In some variations, the mixing apparatus may include a premixing fluidic system. The premixing fluidic system may include circuitry to control mixing of ink reservoir elements prior to printing. In some variations, the premixing fluidic system may additionally include additional wells/reservoirs for storage of the mixed ink solution prior to printing.

In some variations, the mixing apparatus may create preprint colors for later use. In these variations, the loading mechanism 230 may take structural color ink solutions from ink reservoirs, create a new color structural color ink in the mixing apparatus, and then send the new color structural color ink to an ink reservoir, wherein the ink reservoir may, or may not, be empty. For example, a printing system may comprise a 3-reservoir system, wherein the 1^{st} ink reservoir contains a red structural color solution, the 2^{nd} ink reservoir contains a blue structural color solution, and the third ink reservoir is empty. In this variation, the loading mechanism may take appropriate proportions of the red structural color solution and the blue structural color solution to make a green structural color solution which is then pumped into the third ink reservoir. During regular operation of the printing system, as the green structural color solution is depleted, the loading mechanism may further make additional green structural color solution to replenish the third ink reservoir, while the red and blue structural ink solutions may be refilled externally.

The loading mechanism 230 may additionally enable production of post print color designs. In certain variations, the printing system may have a post print coloring mode, wherein color designs may be constructed on the substrate and not prior to printing. In these variations, the loading mechanism 230 may determine and pump structural color solutions to the depositing mechanism 220 one at a time. Once the depositing mechanism 220 has printed a pass on the substrate, the loading mechanism 230, may then pump a different structural color solution into the depositing mechanism to enable a subsequent print pass on the substrate.

Depending on implementation, multi-pass post print color designs may be additive coloring or hybrid (i.e., additive/subtractive) coloring, wherein the system components may function differently depending on this factor. The loading mechanism 230 may determine an “optimal” ordering of structural color solutions to achieve desired brightness of the print. Additionally, the depositing mechanism 230 may pause between passes to enable each print pass to dry prior to the addition of a subsequent print pass. In additive coloring variations, the depositing mechanism 230 may preferably not include pauses to enable mixing of the structural color solutions on the substrate.

In many variations, the printing system may include, or be connected to, a processor to enable color calculations. That is, the printing system may leverage a processor capability to determine the appropriate amounts of structural color solutions necessary to create prints and/or to create specific colors. This processing may take into account differences necessary for additive and subtractive coloring.

In some variations, the printing system may include components for post-processing. In one example, the printing system includes a heating or UV curing element. The heating or UV curing element may function to heat the printing solution or initiate reactivity of the ink. This may be particularly useful for inkjet implementations. The heating or UV curing element may function in conjunction with the inkjet printer head, wherein the heating element warms the inkjet solution for ink solution dispersion. The heating element may function to maintain beneficial solution properties for efficient jetting.

### 4. Method

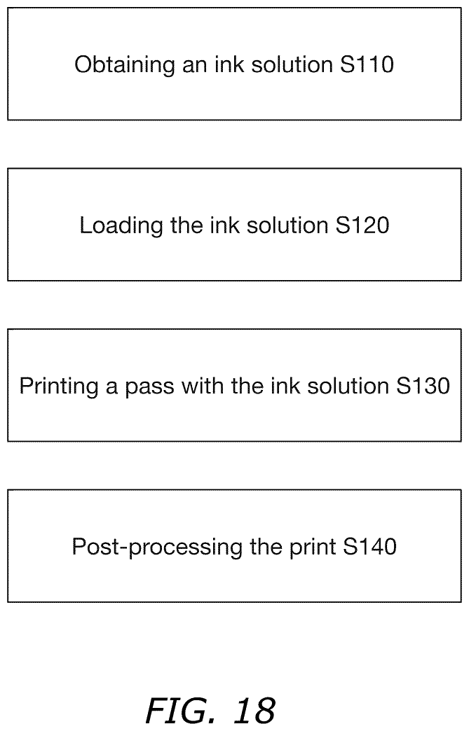

As shown in FIG. 18, a method for printing with a structural color ink solution includes: obtaining an ink solution S110; loading the ink solution S120; and printing a pass with the ink solution S130. Obtaining the ink solution may include adjusting the ink solution for appropriate printing conditions, thereby: setting the ink solution base colors, setting the ink solution viscosity, and setting the ink solution dry time. Loading the ink solution S120 may include mixing the ink solution. Printing a pass with the ink solution S130, may include: printing a desired design and implementing a dry time delay. In some variations, the method may include printing multiple passes (e.g., of a printhead) to deposit additional layers, or may include using multiple printheads to deposit additional layers. In some variations, the method may include a post-processing step, i.e., post-processing the print S140. Post-processing the print S140 may be implemented after each successive layer, or after all layers have been deposited.

The method functions to print a structural color design on a desired target object (i.e., substrate) using a block polymer photonic crystal forming ink solution. The method enables multiple implementations of multi-color printing. That is, the method may enable both premixed colors to be implemented, and/or layering of colors. Using premixed colors comprises premixing a desired color prior to printing the desired color. Layering colors, may include printing multi-pass color layers to obtain a desired color. The method may be preferably implemented with the structural color ink solution system as described above but may be generally implemented for any photonic crystal forming ink based printing solution, including targeting wavelengths outside of the visible spectrum (ultraviolet and near-infrared).

By leveraging a structural color-based ink solution, the method may provide: additive coloring steps and/or hybrid (additive/subtractive) coloring steps; wherein one type of coloring or a combination of coloring methods may be used to color a substrate. The method may be implemented with previously created colorations. For example, the method may enable an additive printing variation (e.g., using the photonic crystal forming inks) with a previously existing set of subtractive colorations (e.g., traditional CMYK inks). That is, the method may enable a structural coloration to be implemented in combination with a pigment or dye coloration. The method coloration may be implemented simultaneously with the pigment or dye coloration (e.g., through premixing), or may be implemented afterwards (e.g., through layering photonic crystal forming ink solutions over or under the pigment or dye coloration layer).

The method may be applicable for use with any printing device, that enables applying a solution to a substrate. The method may be particularly applicable to printers (e.g., an inkjet printer). For example, for an inkjet printer implementation, loading the ink solution S120 may further comprise heating the ink solution; but may be generally used with any type of print method with minor changes to implementation steps dependent on the printing method. As part of an inkjet implementation, the method may be implemented for both continuous inkjet (CIJ) with print frequencies up to 80-100 kHz and drop-on-demand inkjet (DOD) with print frequencies up to 10-50 kHz, and drop speeds up to 4-10 m/s, wherein the method may be implemented for piezoelectric DOD, MEMS printing, and any other type of inkjet printing. Additionally, the method may be implemented with non-inkjet forms of such as: screen printing, roto-screen printing, flexographic printing, roto-gravure printing, and offset printing.

As part of any printing implementation, the method may be implemented for premixed color printing, and/or post print color mixing. For premixed printing, the desired color for a print may be mixed prior to applying the solution to a substrate, such that through a single pass, the desired color is directly printed. In variations that include premixed color printing, loading the ink solution S120 may further comprise mixing the ink solution to the appropriate color. In some variations for premixed color printing, obtaining an ink solution S120 may comprise obtaining multiple ink solutions, wherein loading the ink solution S120 would then comprise mixing the multiple ink solutions.

For post print color mixing, the desired color may be achieved by mixing/layering colors on the substrate (i.e., achieve the desired color after printing). That is, the ink solution is printed with a fixed set of colors, and the desired color is achieved by multiple printing passes. Ink solution colors are thus layered until the desired color is achieved. Post printing color mixing may comprise either additive (e.g., RGB), subtractive coloring (e.g., CMYK), some hybrid combination of additive and subtractive coloring. For post print color mixing implementations, printing a pass with the ink solution S130 may be called multiple times (i.e., printing multiple passes) to achieve the desired design, brightness, and color thickness/opacity, with the desired color(s). For additive post print color mixing, multiple photonic crystal forming inks may be enabled/allowed to mix on the substrate to achieve the desired color. For hybrid additive/subtractive post print color mixing, multiple photonic crystal forming inks and pigmented inks may be enabled/allowed to mix on the substrate to achieve the desired color. There may be a drying time between each pass, such that the ink solutions dry on top of each other to provide the desired hybrid additive/subtractive coloring.

Dependent on the type, and color, of the printing implementation, obtaining an ink solution S110 may comprise obtaining multiple ink solutions (e.g., different reflected wavelengths). In this manner, obtaining an ink solution S110, may additionally include setting the ink solution base colors. Setting the ink solution base colors may function to enable different types of coloring (e.g., additive and/or hybrid additive/subtractive printing) and set the parameters for a printing implementation. For example, for an additive printing implementation, obtaining three: red, blue, and green base color ink solutions, may set the limit for the printed color gamut to the RGB gamut. Obtaining an ink solution S110 may similarly include setting base ink solutions targeting reflected wavelengths outside of the visible spectrum (e.g., ultraviolet or infrared).

For a premixing example, obtaining an ink solution S110 may comprise obtaining ink solutions that would form photonic crystals reflecting a desired wavelength range. In one full visible spectrum range implementation, obtaining an ink solution S110 may comprise obtaining an ink solution that corresponds to photonic crystals with reflection at a wavelength of approximately 400 nm and a second ink solution that corresponds to photonic crystals with reflection at a wavelength of approximately 750 nm. In one ultraviolet spectrum range implementation, obtaining an ink solution S110 may comprise obtaining an ink solution that corresponds to photonic crystals with reflection at a wavelength range of approximately 200 nm to 400 nm. In one near-infrared range implementation, obtaining an ink solution S110 may comprise obtaining an ink solution that corresponds to photonic crystals with reflection at a wavelength range of approximately 750 nm to 2000 nm.

In some printer implementations, obtaining an ink solution S110 may comprise receiving at least one ink reservoir at a printer system. This may correspond to filling, or setting up, the ink reservoirs for the printer system. Depending on the printer system, the color, thickness, and general composition of the ink solution may be implementation dependent.

Block S120, which includes loading the ink solution, functions to prep the ink solution and or ink solutions for printing. Loading the ink solution S120 may vary depending on the printing implementation. For example, for inkjet printing, loading the ink solution S120 may include heating the ink solution. For a premixing color implementation, the loading the ink solution S120 may include mixing the ink solution to the desired color. In multi-pass implementations, loading the ink solution S120 may be called between each printing pass (e.g., where a new color is loaded from an ink reservoir to the printer head).

As part of an ink jet implementation, loading the ink solution S120 may include heating the ink solution. Heating the ink solution may function to alter the ink solution properties for printing. Heating the ink solution may be specific to the inkjet head, such that ink does not clog the head, and droplets released by jetting of the ink solution are of a desired volume and velocity.

As part of a preprint color implementations, loading the ink solution S120 may include mixing the ink solution. That is, for desired preprint color, loading the ink solution S120 may include: determining the base color combinations and their respective ratios for creating the desired print color and then combining and mixing the ink solutions in the appropriate ratios. Mixing the ink solution may vary dependent on the system implementation. In many variations, the mixing the ink solution may use the already implemented mixing components of the system for mixing. As the common current printer technology does not incorporate a preprint color, additional components may need to be incorporated for mixing the ink solution. Any general mixing techniques may be used. Examples of mixing techniques that may be used for mixing the ink solution include: mechanical mixing, magnetic force mixing, high shear mixing, sonication, centrifugal mixing, or planetary mixing.

Block S130, which includes printing a pass with the ink solution, functions to print a desired pattern on the target material (substrate). In some variations (e.g., in a preprint color mixing variations that incorporates a single color), printing a pass with the ink solution S130 may comprise printing only a single pass, wherein the desired pattern is printed with the desired color(s) directly. For other implementations, printing a pass with the ink solution may be called multiple times, for example: to incorporate different colors for printing, to create new colors for post print coloring, and/or to create complex designs that require multiple printing passes.

In some variations (e.g., post print color mixing), printing a pass with the ink solution S130, may be called multiple times. In these variations, one or multiple, colors may be printed in one pass. Dependent on implementation, the ink solution may then be allowed to dry prior to printing an additional pass.

Additionally or alternatively, the method may include post print additive coloring. For additive post print coloring, printing a pass with the ink solution S130 may print either a single color or multiple colors simultaneously. Additional printing passes may deposit different color ink solutions to achieve the desired post print color. As a distinction to subtractive post print coloring, additional passes are printed prior to the ink solution drying, thereby creating a single film on the substrate with the desired post print color. In some variations, “mixing” techniques may be incorporated to better mix the deposited ink solution on the substrate. Examples of post print mixing techniques that can be incorporated include: inducing mixing through a magnetic field or electrical stimulus, heating the ink solution, or sonication.

In variations for inkjet printing, printing a pass with the ink solution S130 may include setting the print speed. Setting the print speed may include setting the ink solution jetting speed and setting the printer head movement speed. The jetting speed and movement speed may be dependent on the specific inkjet implementation and ink solution mixture. Preferably the jetting speed is chosen such that the released ink solution drops are of appropriate volume and velocity. The printing speed may additionally include allowing drying time for the layering of multiple colors (e.g. during additive color mixing).

In some variations, the method may include post-processing the print S140. Post-processing the print S140 may function to modify the print after printing. Dependent on the implementation, post-processing the print S140 may occur after: a single printing pass; directly after each, some, or all printing passes; after all printing has been completed, or any variation thereof. Post-processing may include drying the print, mixing multiple print passes, stabilizing the print, cross-linking the print, or enhancing or altering the print in some other manner. In some variations, post-processing the print may include printing a protective overprint varnish, clear coat, or some other surface material on the print.

In some variations, post-processing the print S140 may include ambient drying or actively drying the print (e.g., by application of an infrared/thermal or UV lamp). Actively drying the print may quickly dry the ink solution to enable efficient multi-pass printing or enable efficient implementation of other types of post-processing. For multi-pass implementations, actively drying the print may partially or fully dry the ink solution after each pass.

In some variations, post-processing the print S140 may include mixing multiple print passes (e.g., for additive post print coloring). This mixing may be incorporated through agitation (e.g., sonication) or mechanical mixing of the multiple print passes. Mixing of multiple print passes preferably occurs directly after printing a pass S130 to prevent the multiple passes from drying prior to combining into a single color.

In another variation, post-processing the print S140 includes stabilizing the print. Stabilizing the print may help better protect the print from environmental and other external factors. Stabilizing the print may include applying a protective coating (e.g., application of a clear resin). In some implementations, stabilizing the print may enable layering of ink solutions such that the colors do not mix. In some implementations, stabilizing the print may involve inducing chemical transformation within the print.

In some variations the method may additionally enable modification of the steps to enable specific operating modes. Examples of possible implemented operating modes include: a print quality operating mode (e.g., high resolution printing versus an ink-saver mode), a speed operating mode (e.g., high through-put speed versus slower high-quality printing), and color operating mode (e.g. color versus black/white printing, or greyscale printing).

As mentioned above, the method may leverage the properties of structural ink solutions to construct color designs through additive or hybrid additive/subtractive coloring; where additive coloring may be incorporated prior to, or after printing onto a substrate, and hybrid additive/subtractive coloring may be incorporated after printing by layering colors. The method may additionally incorporate any combination of: preprint additive coloring, post print additive coloring, and post print hybrid additive/subtractive coloring.

For example, the system may include obtaining two ink solutions initially. Through preprint additive coloring the two ink solutions maybe be combined to form ink solutions for red, green, and blue. These colors are then printed, and post print coloring is used to create designs in the RGB gamut using the red, green, and blue ink solutions.

The method may be highly implementation specific and may include many variations dependent on the implemented printing system and the desired method of coloring. In one variation, a printing method for structural ink may include: receiving at a printer system, at least one reservoir of photonic crystal forming ink, wherein the photonic crystal ink comprises a solution that once printed onto a substrate, dries into a photonic crystal film of a designated color; loading the ink solution, thereby preparing the photonic crystal forming ink for printing; and printing the ink solution, thereby depositing a first layer photonic crystal film. Dependent on implementation, the method may further include post-processing the photonic crystal film. In one variation, post-processing the photonic crystal film includes adding a protective clear coat or overprint varnish onto the photonic crystal film. In another variation, post-processing the photonic crystal film includes actively drying the photonic crystal film.

The method may be particularly suited for preprint additive color mixing. In these variations, a printing method for structural ink may include: receiving at a printer system, at least one reservoir of photonic crystal forming ink, wherein the at least one reservoir of photonic crystal forming ink includes at least two reservoirs of photonic crystal forming ink; loading the ink solution, comprising mixing the at least two reservoirs of photonic crystal forming ink to achieve a preprint desired color ink solution and preparing the desired color ink solution for printing; printing the ink solution, thereby depositing a first layer photonic crystal film corresponding to the preprint desired color; and post-processing the photonic crystal film.

Dependent on implementation for preprint additive color mixing, the method may incorporate coloring using a minimum of two reservoirs. In a two-ink example of the preprint additive coloring, the at least two reservoirs of photonic crystal ink correspond to two reservoirs, a first photonic crystal ink and a second photonic crystal ink and the mixing the two reservoirs of photonic crystal ink comprises setting the preprint desired color by the ratio of the first photonic crystal ink and the second photonic crystal ink.

The method additionally allows preprint coloring using more conventional three-color additive coloring (e.g., RGB color gamut). For example, in the three reservoir coloring, the at least two reservoirs of photonic crystal ink comprises three reservoirs of photonic crystal ink: a first photonic crystal ink (e.g., corresponding to a red color ink), a second photonic crystal ink (e.g., corresponding to a green color ink), and a third photonic crystal ink (e.g., corresponding to a blue color ink) and the mixing the three reservoirs of photonic crystal ink comprises setting the preprint desired color by the ratio of the first photonic crystal ink, the second photonic crystal ink, and the third photonic crystal ink.

The method also allows itself to be incorporated for post print coloring. In a post print coloring variation, a printing method for structural ink may include: receiving at a printer system, at least one reservoir of photonic crystal forming ink, wherein the at least one reservoir of photonic crystal forming ink comprises receiving at least two reservoirs of photonic crystal forming ink; loading the ink solution, comprising loading a single photonic crystal forming ink at a time; printing the ink solution, comprising printing multiple passes over a substrate with a different photonic ink solution; and post-processing the photonic crystal film.

As an example of an additive post print color, printing multiple passes over a substrate includes mixing the printed ink solutions, such that once dried, only a single layer film of the determined post print color is deposited on the substrate. As part of a “traditional” RGB implementation for post print coloring, the at least two reservoirs of photonic crystal ink may comprise three reservoirs of photonic crystal ink: a first photonic crystal ink corresponding to a red color ink, a second photonic crystal ink corresponding to a green color ink, and a third photonic crystal ink corresponding to a blue color ink and printing the ink solution, comprising: printing the calculated amount of the first photonic crystal ink, printing the calculated amount of the second photonic crystal ink, printing the calculated amount of the third photonic crystal ink, and mixing the photonic crystal ink solutions.

The method may also allow itself to be incorporated for hybrid additive/subtractive printing. For a hybrid additive/subtractive post print color, printing a pass with an ink solution, for multiple passes, may include, for each printed pass, printing with a different photonic ink solution or with a different subtractive color ink solution. Post processing the photonic crystal film may then include drying the photonic crystal film and/or drying the subtractive color ink film, such that once completed, a multi-layer film is deposited on the substrate corresponding to the determined post print color.

Additionally in some variations, the at least two reservoirs of the of photonic crystal ink may comprise four reservoirs of ink solution: a first photonic crystal ink corresponding to a red color ink, a second photonic crystal ink corresponding to a green color ink, a third photonic crystal ink corresponding to a blue color ink and a fourth ink subtractive color ink solution (e.g., a black/other color pigment or dye). In this variation, printing the ink solution, may then include: printing the calculated amount of the first photonic crystal ink, printing the calculated amount of the second photonic crystal ink, printing the calculated amount of the third photonic crystal ink, printing the calculated amount of the fourth subtractive color ink; and post-processing the photonic crystal film comprises: drying the first photonic crystal ink layer, drying the second photonic crystal ink layer, drying the third photonic crystal ink layer, and drying the subtractive color ink layer ink layer. In alternative variations, the incorporated subtractive color ink solution may comprise an entire subtractive color gamut (e.g., CMYK gamut).

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A composition for a printable photonic crystal forming ink solution comprising:
at least one block copolymer; and
at least one solvent.

2. The system of claim 1 further comprising at least one co-binder.

3. The system of claim 2, wherein the at least one solvent includes a reactive monomer or oligomer.

4. The system of claim 2, wherein the at least one solvent includes water.

5. The system of claim 2, wherein the at least one co-binder includes crosslinking functional groups.

6. The system of claim 3, wherein the at least one co-binder comprises sucrose acetate iso-butyrate (SAIB-100).

7. The system of claim 3, wherein the at least one co-binder comprises sucrose benzoate.

8. The system of claim 3 further comprising a swelling agent.

9. The system of claim 8, wherein the swelling agent includes crosslinking functional groups

10. The system of claim 3, wherein the composition has a combined dry state prior to the addition of the at least one solvent, such that with addition of the at least one solvent, becomes a functional printable photonic crystal forming ink solution.

11. A printing method for structural ink comprising:
receiving at a printer system, at least one reservoir of photonic crystal forming ink,
wherein the photonic crystal ink comprises a solution that once printed onto a substrate, forms a photonic crystal film of a designated color;
loading the ink solution, thereby preparing the photonic crystal forming ink for printing; and
printing the ink solution, thereby depositing a first layer photonic crystal film.

12. The method of claim 11 wherein printing the ink solution comprises printing multiple passes thereby depositing multiple layers of photonic crystal film.

13. The method of claim 11, further comprising post-processing the photonic crystal film.

14. The method of claim 13 wherein post-processing the photonic crystal film includes adding a protective clear coat or overprint varnish onto the photonic crystal film.

15. The method of claim 13, wherein post-processing the photonic crystal film comprises actively drying or curing the photonic crystal film.

16. The method of claim 12, wherein:
receiving at least one reservoir of photonic crystal forming ink comprises receiving at least two reservoirs of photonic crystal forming ink; and
loading the ink solution comprises mixing the at least two reservoirs of photonic crystal forming ink to achieve a preprint desired color ink solution; and
printing the ink solution comprises depositing a first layer photonic crystal film corresponding to the preprint desired color.

17. The method of claim 16, wherein:
the at least two reservoirs of photonic crystal ink comprises two reservoirs of photonic crystal ink, a first photonic crystal ink and a second photonic crystal ink and
the mixing the two reservoirs of photonic crystal ink comprises setting the preprint desired color by the ratio of the first photonic crystal ink and the second photonic crystal ink.

18. The method of claim 16, wherein:
the at least two reservoirs of photonic crystal ink comprises three reservoirs of photonic crystal ink:
a first photonic crystal ink corresponding to a red color ink,
a second photonic crystal ink corresponding to a green color ink, and a third photonic crystal ink corresponding to a blue color ink and.
the mixing the three reservoirs of photonic crystal ink comprises setting the preprint desired color by the ratio of the first photonic crystal ink, the second photonic crystal ink, and the third photonic crystal ink.

19. The method of claim 11, for a post print coloring mode further comprising:
wherein receiving at least one reservoir of photonic crystal forming ink comprises receiving at least two reservoirs of photonic crystal forming ink;
determining a post print color, comprising calculating the amount of each photonic crystal ink required to create the post print color;
loading the ink solution comprising loading a single photonic crystal forming ink at a time; and
printing the ink solution, comprises printing multiple passes over a substrate with a different photonic ink solution.

20. The method of claim 19, for an additive post print color, wherein printing multiple passes over a substrate includes mixing the printed ink solutions, such that once dried, only a single layer film of the determined post print color is deposited on the substrate.
